(19) United States
(12) Patent Application Publication
(10) Pub. No.: US 2007/0276515 A1
(43) Pub. Date: Nov. 29, 2007

(54) Control System for a Motor Vehicle

(75) Inventors: Manfred Dorn, Stuttgart (DE); Volker Hellwig, Stuttgart (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/584,444

(22) PCT Filed: Dec. 7, 2004
(86) PCT No.: PCT/EP04/13889

§ 371 Date: Jun. 27, 2007

(30) Foreign Application Priority Data
Dec. 23, 2003 (DE) 103 60 663.7

(51) Int. Cl. G05B 15/00

(52) U.S. Cl. 700/83

(57) ABSTRACT

A control system for a motor vehicle is provided. The control system includes a manual actuating device with a plurality of degrees of freedom of adjustment for selecting and/or activating entries in a menu structure with a plurality of menu levels and a screen display having one or more display areas for displaying the menu structure, each display area including at least one field for displaying one of the entries. To display entries in at least one menu level of the menu structure, a plurality of fields in a matrix structure including a plurality of columns and a plurality of rows which can each be selected by a cursor are arranged in at least one display area of the screen display, in which only one entry is arranged in each of the columns or in each of the rows.

### CROSS REFERENCE TO RELATED APPLICATIONS

This application is a continuation of PCT International Application No. PCT/EP2004/013889, filed on Dec. 7, 2004, which claims priority under 35 U.S.C. §119 to German Patent Application No. 103 60 663.7, filed Dec. 23, 2003, the entire disclosures of which are herein expressly incorporated by reference.

### BACKGROUND AND SUMMARY OF THE INVENTION

The present invention relates to a control system for a motor vehicle.

In modern vehicles, multimedia control systems are being increasingly used. An example of this is the command system used in Mercedes Benz S-class vehicles.

DE 197 52 056 A1 describes a generic control system for a motor vehicle. In this control system, two display areas are displayed on a screen display in a menu structure with a plurality of menu levels. A first display area is arranged as a frame around the second display area. In a first menu level, eight fields with entries which correspond to applications which can be carried out and which are arranged vertically and horizontally are displayed in the first display area. An entry is selected by means of a pushing or tilting movement of the manual actuating means with a plurality of degrees of freedom of adjustment in the direction of the position of the corresponding entry in the first display area. A selected entry is activated by pressing the manual actuating means. After the activation, a plurality of vertically arranged entries which are assigned to the activated entry in the first menu level are displayed in a second menu level in the second display area. The entries displayed in the second display area are selected by means of rotational movement of the manual actuating means and activated by pressing the manual actuating means. The activated second display area and the second menu level are exited by means of the pushing or tilting movement of the manual actuating means in the direction of a position of one of the entries in the first display area. The control system is then located in the first menu level in the first display area again.

An object of the present invention is to specify an improved control system for a motor vehicle which permits intuitive control and which reduces the scope of distracting information.

Exemplary embodiments of the present invention include arranging a plurality of fields in a matrix structure composed of a plurality of columns and a plurality of rows in order to display entries in at least one display area of a screen display. The fields can each be selected by means of a cursor, only one entry being arranged in each of the columns or in each of the rows. As a result, the entries can be arranged in an easily understood fashion and selected easily.

The at least one display area represents, for example, a radio function, and the entries in the fields correspond to selectable radio stations.

In one development of the invention, the fields in the matrix can be filled by the user with entries from stored lists in a variable fashion. The stored lists may be, for example, various transmitter lists which are produced as a function of user settings and stored. A stored transmitter list may comprise the currently receivable radio stations.

In order to select the entries, the matrix may be embodied, for example, as a virtual endless conveyor belt which can be moved through under the cursor by the manual actuating means in accordance with the degree of freedom of adjustment.

The cursor may be configured, for example, as a fixed or movable bar. The cursor which is embodied as a movable bar can be moved over the matrix by the manual actuating means in order to select one of the entries.

In one advantageous configuration, the cursor can be moved over the matrix within a predefined area in order to select an entry, and the cursor may be stopped when one of the area boundaries is reached. This area may be three-sevenths of the possible movement area, and the matrix may be stationary, if the movable cursor is positioned within the predefined area. The matrix may be moved through under the cursor in accordance with the degree of freedom of adjustment, when the cursor reaches one of the area boundaries and the manual actuating means continues to be actuated with the same degree of freedom of adjustment. However, the area can also be of a different size or can comprise the entire possible movement area.

In a further configuration, the matrix is moved counter to the direction of movement of the cursor by the same degree of freedom of adjustment of the actuating means if the cursor reaches one of the area boundaries or is positioned on the area boundary.

In order to display the entries in a more easily understood fashion, the entries are displayed in adjacent columns in fields of different rows, if the number of columns is greater than or equal to the number of rows.

The selection of one of the entries by moving the cursor which is configured as a vertical bar or the matrix which is configured as a virtual conveyor belt is then carried out with the manual actuating means by using a first, second, third or fourth degree of freedom of adjustment.

The display area can be exited with a fifth or sixth degree of freedom of adjustment of the manual actuating means.

Alternatively, the entries are displayed in adjacent rows in fields of different columns if the number of columns is less than the number of rows.

The selection of one of the entries is then carried out by moving the cursor, which is configured as a horizontal bar, or the matrix, which is configured as a virtual conveyor belt, by using the fifth, sixth, third or fourth degree of freedom of adjustment of the manual actuating means.

In a further configuration, the display area can be exited by using the first or the second degree of freedom of adjustment of the manual actuating means.

The activation of the selected entry can be carried out, for example, by ending the movement or by an additional seventh degree of freedom of adjustment of the manual actuating means. That entry in whose field the cursor is located when activation occurs is activated.

In one advantageous configuration, the selected and/or activated entry is displayed graphically in a different way than the other entries. As a result, the selected and/or activated entry may be displayed, for example, with a larger size and/or with a different color and/or with a higher intensity than the other entries.

The width of the individual fields is dependent, for example, on the length of the longest entry in the respective column.

The field width may be additionally or alternatively dependent on the number of columns.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block circuit diagram of a control system for a motor vehicle;

FIG. 2 is a schematic illustration of a screen display from FIG. 1 in a first menu level;

FIG. 3 is a schematic illustration of a display area of the screen display from FIG. 1;

FIG. 4 is a schematic illustration of the screen display from FIG. 1 in a third menu level; and

FIG. 5 is an alternative schematic illustration of the screen display from FIG. 1 in the third menu level.

### DETAILED DESCRIPTION OF THE DRAWINGS

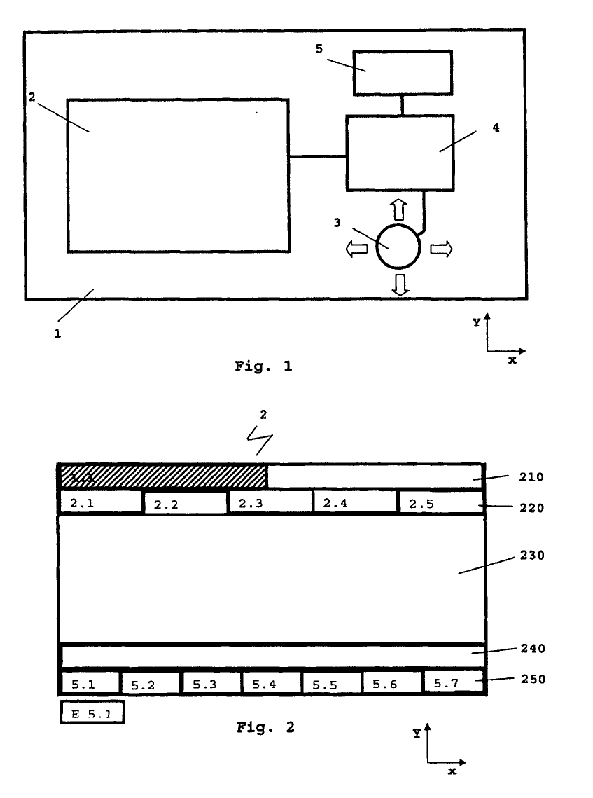

As illustrated in FIG. 1, the control system 1 for a motor vehicle comprises a screen display 2, a manual actuating means 3, a control and evaluation unit 4 and a plurality of vehicle systems such as a navigation system, a heating system and an air conditioning system, a cellular telephone, a video system, an audio system, etc., which are illustrated combined as one element 5. The vehicle systems transmit signals to the evaluation and control unit 4 from which the control and evaluation unit 4 determines current system states. All the applications and/or functions and/or subfunctions and/or options and/or status displays in various menu levels of a menu structure are controlled by the manual actuating means 3. The latter has seven degrees of freedom of adjustment for selecting and/or activating entries displayed in an active display area. The actuating means 3 can be pushed in four directions according to the arrow illustration in FIG. 1, i.e., in a positive x direction, a negative x direction, in a positive y direction or in a negative y direction. In addition, it can be rotated in the clockwise direction or in the counter clockwise direction about a z axis (not illustrated) which is perpendicular to the plane of the drawing, and can be pressed in the direction of the negative z direction, i.e., into the plane of the drawing.

Rotating the manual actuating means 3 in the clockwise direction causes a cursor on the screen 2 to move to the right or downward as a function of a horizontal or vertical orientation of the entries displayed on the screen display 2, and turning in the counter clockwise direction causes the cursor to move to the left or upward. Pushing the manual actuating means 3 in FIG. 1 upward, i.e., forward in the direction of the windshield, i.e., in the positive y direction, causes the cursor on the screen display 2 to move upward. The pushing process in the downward direction in FIG. 1, i.e., toward the rear in the negative y direction, causes the cursor on the screen display 2 to move downward. Pushing to the right, i.e., in the positive x direction, causes the cursor on the screen display 2 to move to the right, and pushing to the left, i.e., in the negative x direction, causes the cursor to move to the left.

The selection and/or activation of an entry displayed on the screen display 2 are carried out by pushing or turning the manual actuating means 3. In a way which is redundant with respect to the vertical pushing along an axis, i.e., with respect to the pushing in the y direction, or with respect to the horizontal pushing along an axis, i.e., with respect to the pushing in the x direction, the manual actuating means 3 can be rotated about the z axis. The pushing movement of the manual actuating means 3 in order to select an entry may correspond to the orientation of the entries displayed in the active display area. The pushing direction which is respectively orthogonal with respect to the selection pushing direction causes the active display area to be exited. In addition, in order to activate a selected entry it may be necessary to press the manual actuating means 3.

As illustrated in FIG. 2, the screen display 2 comprises, in a first menu level, a graphic basic structure of five vertically arranged, horizontal display areas 210 to 250. This graphic basis structure is constant over the multiplicity of various menu levels of the menu structure. The screen display 2 is configured, for example, as an eight inch screen with a ratio of the sides of 15:9. The graphic basic structure of at least a first of the display areas 210 to 250 of the screen display 2 is constant over the multiplicity of various menu levels of the menu structure. In FIG. 2, the display areas 210, 220, 240 and 250 are configured as such first display areas.

The graphic basis structure of at least a second of the display areas 210 to 250 is variable over the multiplicity of various menu levels of the menu structure as a function of an activated application and/or function and/or subfunction and/or option and/or status display. In FIG. 2, the display area 230 is configured as a second display area. This central display area 230 may be configured graphically in very different ways.

One or more horizontally arranged entries 1.1 to 5.7 may be respectively displayed in the four display areas 210, 220, 240 and 250, which are configured as first display areas. For example, the display areas 210, 220, 240 and 250 in FIG. 2 in the first menu level each comprise a different number of entries. For example, the first display area 210 comprises one entry 1.1, the second display area 220 comprises five entries 2.1 to 2.5, the fourth display area comprises no entry and the fifth display area comprises seven entries 5.1 to 5.7. In FIG. 2, the first display area 210 is activated and the hatched entry 1.1. is selected. The hatched display is intended to indicate that the cursor is positioned on the entry 1.1.

The entries 1.1 to 5.7 of the display areas 210 to 250 displayed on the screen display 2 can be arranged according to the importance of their contents or their frequency of application. When the entries are arranged vertically, the width of the individual fields for displaying the entries 1.1 to 5.7 is dependent, for example, on the length of the longest entry. The field width can additionally or alternatively be dependent on the number of fields in a display area.

FIG. 3 shows a possible implementation of a display area 230.1 which is embodied as a matrix, within the third display area 230. As illustrated in FIG. 3, the matrix in the exemplary embodiment shown comprises five columns S1 to S5 and three rows Z1 to Z3. Since the number of columns is greater than the number of rows, the display area 230.1 which is embodied as a matrix has a significantly greater extent in the horizontal direction than in the vertical direction. In order to make the selection easier to understand, in each case just one entry E1 to E5 is arranged in each of the columns S1 to S5, the entries E1 to E5 being arranged in adjacent columns S1 to S5 in fields of different rows Z1 to Z3. The individual fields in the display area 230.1 can be selected by means of a cursor 231. The described matrix structure is used in particular to select transmitters within the process of controlling a radio function. Since the arrangement of the possible entries gives a similar impression to that of an old analog radio by graphic means, the recognition value for the user is very high, which facilitates intuitive control of the radio function.

In the example in FIG. 3, the matrix 230.1 is configured as a virtual endless conveyor, and the cursor 231 is configured as a fixed vertical bar. In order to select one of the entries E1 to E5, the manual actuating means 3 moves the matrix 230.1 under the cursor 231 by using of a first, a second, a third or a fourth degree of freedom of adjustment. The active display area 230.1 can be exited by means of a fifth or sixth degree of freedom of adjustment of the manual actuating means 3. An arrow 232 indicates that even more than the five illustrated entries are entered in the matrix which is configured as a conveyor belt and which can be selected by moving the manual actuating means 3.

In an alternative embodiment (not illustrated), the matrix 230.1 is fixed and the cursor 231 is configured as a movable bar. In order to select one of the entries E1 to E5, the movable bar is moved over the matrix 230.1 by the manual actuating means 3 with the aforesaid degrees of freedom of adjustment.

In a further alternative embodiment (not illustrated), the two embodiments are combined, i.e., the cursor 231 is embodied as a movable bar within a predefined area which takes up, for example, 3/7 of the possible movement area, and the matrix 230.1 is not moved if the cursor 231 is positioned within this area. If the cursor reaches one of the area boundaries, the cursor 231 is stopped and then acts as a fixed bar under which the matrix 230.1, which is configured as a conveyor belt, is moved through if the manual actuating means continues to be actuated with the same degree of freedom of adjustment. When the manual actuating means 3 is actuated, the matrix 230.1 may move in the opposite direction to the direction of movement of the cursor 231 and with the same degree of freedom of adjustment. The predefined area can also correspond to the entire possible movement area. An entry is selected within the predefined area by positioning the cursor 231 on the entry. If the cursor 231 reaches the area boundary, the matrix 230.1 which is configured as a conveyor belt continues to be moved and the selection is made by positioning a desired entry under the cursor 231.

The first degree of freedom of adjustment of the manual actuating means 3 corresponds to pushing it in a positive x direction, and the second degree of freedom of adjustment of the manual actuating means 3 corresponds to pushing it in a negative x direction. These two degrees of freedom of adjustment correspond to the horizontal main orientation of the entries E1 to E5 in the display area 230.1.

Furthermore, the third degree of freedom of adjustment of the manual actuating means 3 corresponds to rotating the manual actuating means 3 in the clockwise direction about the z axis in order to move the cursor in the example in FIG. 3 to the right or in the positive x direction. The sixth degree of freedom of adjustment of the manual actuating means 3 may correspond to rotating the manual actuating means 3 in the counterclockwise direction about the z axis in order to move the cursor to the left or in the negative x direction.

The fifth degree of freedom of adjustment of the manual actuating means 3 may correspond to pushing the manual actuating means 3 in the positive y direction, and the sixth degree of freedom of adjustment of the manual actuating means 3 may correspond to pushing the manual actuating means 3 in the negative y direction. These two degrees of freedom of adjustment are orthogonal with respect to the horizontal main orientation of the entries E1 to E5 in the display area 230.1.

The selected entry E1 to E5 can be activated by ending the movement or by an additional seventh degree of freedom of adjustment of the manual actuating means 3, the entry E1 to E5 in whose field the cursor 231 is then positioned being activated. In the illustrated exemplary embodiment this is the entry E3 which is represented by hatching.

In order to display the selected and/or activated entry E3, the latter can have a different graphic representation than the other entries. For example, the selected and/or activated entry E3 can be displayed with a larger size and/or with a different color and/or with a higher intensity than the other entries.

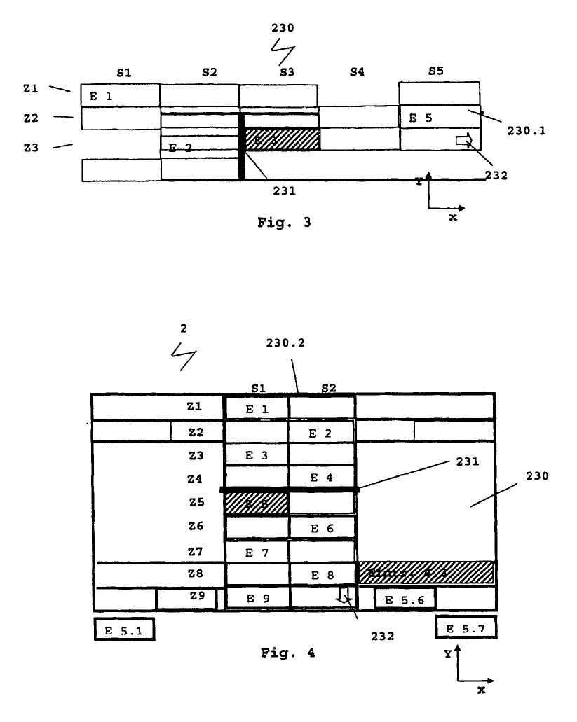

FIG. 4 shows a further possible implementation of a display area 230.2, configured as a matrix, within the third display area 230. As illustrated in FIG. 4, the matrix comprises two columns S1 and S2 and nine rows Z1 to Z9. Since the number of columns is smaller than the number of rows, the display area 230.2 which is configured as a matrix has a significantly larger extent in the vertical direction than in the horizontal direction. In order to make the selection easier to understand, in each case just one entry E1 to E9 is arranged in each of the rows Z1 to Z9, the entries E1 to E9 being displayed in adjacent rows Z1 to Z9 in fields of different columns S1 and S2. The individual fields in the display area 230.2 can be selected by means of the cursor 231. The described matrix structure is also used in particular to select transmitters within the process of controlling a radio function.

In the example in FIG. 4, the matrix 230.2 is configured as a virtual endless conveyor belt, and the cursor 231 is configured as a fixed horizontal bar. In order to select one of the entries E1 to E9, the manual actuating means 3 moves the matrix 230.2 under the cursor 231 by means of the fifth, the sixth, the third or the fourth degree of freedom of adjustment. The active display area 230.2 can be exited by using the first or the second degree of freedom of adjustment of the manual actuating means 3. An arrow 232 indicates that even more than the illustrated nine entries E1 to E9 are entered in the matrix 230.2 which is configured as a conveyor belt and the entries can be selected by moving the manual actuating means 3.

In an alternative embodiment (not illustrated), the matrix 230.2 is configured in a fixed fashion and the cursor 231 is configured as a movable bar. In order to select one of the entries E1 to E9, the movable bar is moved over the matrix 230.2 by the manual actuating means 3 with the aforesaid degrees of freedom of adjustment.

In a further alternative embodiment (not illustrated), the two embodiments are combined, i.e., the cursor 231 is embodied as a movable bar within a predefined area which takes up, for example, 3/7 of the possible movement area, and the matrix 230.2 is not moved if the cursor 231 is positioned within this area. If the cursor reaches one of the area boundaries, the cursor 231 is stopped and then acts as a fixed bar under which the matrix 230.2, which is configured as a conveyor belt, is moved, if the manual actuating means continues to be actuated with the same degree of freedom of adjustment. When the manual actuating means 3 is actuated with the same degree of freedom of adjustment, the matrix 230.2 may move in the opposite direction to the direction of movement of the cursor 231. The predefined area can also correspond to the entire possible movement area. An entry is selected within the predefined area by positioning the cursor 231 on the entry. If the cursor 231 reaches the area boundary, the matrix 230.2 which is embodied as a conveyor belt continues to be moved and the selection is carried out by positioning a desired entry under the cursor 231.

In the example in FIG. 4, the first and second degrees of freedom of adjustment of the manual actuating means 3, i.e., the pushing thereof in the positive or negative x direction, are orthogonal with respect to the vertical main orientation of the entries E1 to E9 in the display area 230.2. The third degree of freedom of adjustment of the manual actuating means 3 corresponds to the rotating thereof in the clockwise direction about the z axis and moves the cursor downward or in the negative y direction. The sixth degree of freedom of adjustment of the manual actuating means 3 corresponds to the rotating thereof in the counterclockwise direction about the z axis and moves the cursor upward or in the positive y direction. The fifth and sixth degrees of freedom of adjustment of the manual actuating means 3, i.e., the pushing thereof in the positive or negative y direction, correspond to the vertical main orientation of the entries E1 to E9 in the display area 230.2.

The activation of the selected entry E1 to E9 can be carried out by ending of the movement or by an additional seventh degree of freedom of adjustment of the manual actuating means 3, the entry E1 to E9 in whose field the cursor 231 is then positioned being activated. In the illustrated exemplary embodiment, this is the entry E5 which is represented by hatching.

In order to display the selected and/or activated entry E5, the latter can be displayed graphically in a different way than the other entries. The selected and/or activated entry E5 can thus be displayed with a larger size and/or with a different color and/or with a higher intensity than the other entries.

The fields in the respective matrix 230.1 and 230.2 in FIGS. 3 and 4 can be filled in a variable fashion by the user with entries from stored lists, i.e., for example with radio stations which can be selected by the user in the case of the aforementioned radio control function.

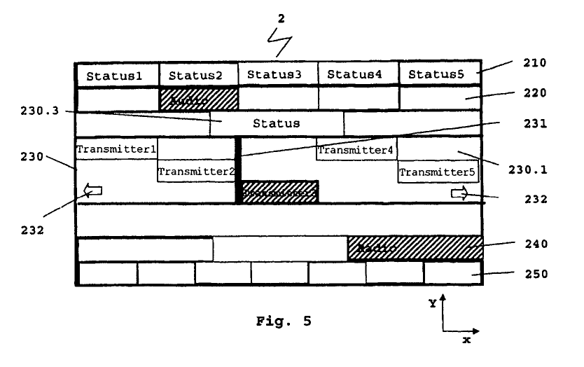

FIG. 5 shows an embodiment of the invention in which the third display area 230 serves for controlling a radio function which is activated in the fourth display area 240 within an audio application which can be activated in the second display area 220. One of a multiplicity of radio stations transmitter 1 to transmitter 5 can be selected within the third display area 230 with the display area 230.1 according to FIG. 3.

The radio stations which can be displayed are stored in at least one transmitter list which is selected by the user. Possible criteria which can be predefined for compiling the at least one transmitter list may, for example, include program types, such as classical, pop, information, etc., or all radio stations which can currently be received. Arrows 232 indicate that even further selectable radio stations are entered in the matrix both to the left and to the right.

The matrix in FIG. 5 is configured, in a way which is analogous to the configuration according to FIG. 3, as a virtual endless conveyor belt, which can be moved through under the cursor 231 with the actuating means 3. A further display area 230.3 with a status field within the third display area 230 serves, for example, for displaying the selection criterion of the currently displayed transmitter list.

The configurations described with respect to the drawings show that the invention can be used to control a very wide variety of applications and/or functions. An easily understood arrangement of the entries is obtained by displaying entries in fields of a matrix structure composed of a plurality of columns and a plurality of rows, only one entry, which can be selected by means of a cursor, being arranged in each of the columns or in each of the rows. In addition, in particular when controlling the radio function, the user is reminded of an analog radio which he can control intuitively. As a result, the control processes are simplified for the user and the cognitive load is reduced so that the user can concentrate better on the events on the road.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-20. (canceled)

21. A control system for a motor vehicle, comprising:
a manual actuating device with a plurality of degrees of freedom of adjustment for selecting or activating entries in a menu structure with a plurality of menu levels; and
a screen display having at least one display area for displaying the menu structure, each of the display areas comprising at least one field for displaying one of the entries;
wherein, in order to display the entries, a plurality of fields with a matrix structure including a plurality of columns and a plurality of rows which are selectable by a cursor are arranged in at least one menu level of the menu structure in at least one display area of the screen display, wherein one of the entries is arranged in each of the columns or in each of the rows.

22. The control system as claimed in claim 21, wherein the fields in the matrix are filled by a user with entries from stored lists in a variable fashion.

23. The control system as claimed in claim 21, wherein the matrix is configured as a virtual endless conveyor belt which is moved through under the cursor by the manual actuating device in accordance with the degree of freedom of adjustment to select one of the entries.

24. The control system as claimed in claim 23, wherein the cursor is configured as a fixed bar.

25. The control system as claimed in claim 21, wherein the cursor is configured as a movable bar which is moved over the matrix by the manual actuating means in order to select one of the entries.

26. The control system as claimed in claim 25, wherein the cursor is moved over the matrix to select an entry within a predefined area, and is stopped when one of the area boundaries is reached, the predefined area being three-sevenths of the possible movement area, the matrix being stationary if the cursor is positioned within the predefined area, and the matrix moving under the cursor in accordance with the degree of freedom of adjustment if said cursor reaches one of the area boundaries and the manual actuating device continues to be actuated with the same degree of freedom of adjustment.

27. The control system as claimed in claim 26, wherein the matrix is moved counter to the direction of movement of the cursor by the same degree of freedom of adjustment of the manual actuating device if the cursor reaches one of the area boundaries or is positioned on the area boundary.

28. The control system as claimed in claim 21, wherein the entries are displayed in adjacent columns in fields of different rows if the number of columns is greater than or equal to the number of rows.

29. The control system as claimed in claim 28, wherein the selection of one of the entries by moving the cursor which is configured as a vertical bar or the matrix which is configured as a virtual conveyor belt is carried out by using at least one of first, second, third and fourth degrees of freedom of adjustment of the manual actuating device.

30. The control system as claimed in claim 29, wherein the display area is exited by using at least one of fifth and sixth degrees of freedom of adjustment of the manual actuating device.

31. The control system as claimed in claim 21, wherein the entries are displayed in adjacent rows in fields of different columns if the number of columns is smaller than the number of rows.

32. The control system as claimed in claim 31, wherein the selection of one of the entries by moving the cursor which is configured as a horizontal bar or the matrix which is configured as a virtual conveyor belt is carried out of using at least one of the third, fourth, fifth and sixth degrees of freedom of adjustment of the manual actuating device.

33. The control system as claimed in claim 32, wherein the display area is exited by using at least one of the first and second degrees of freedom of adjustment of the manual actuating device.

34. The control system as claimed in claim 21, wherein a selected entry is activated by ending the movement or by using an additional seventh degree of freedom of adjustment of the manual actuating device, the respective entry in whose field the cursor is then positioned being activated.

35. The control system as claimed in claim 34, wherein the selected or activated entry is displayed graphically in a different way than other entries.

36. The control system as claimed in claim 35, wherein the selected or activated entry is displayed with at least one of a larger size, a different color and a higher intensity than the other entries.

37. The control system as claimed in claim 21, wherein the width of individual fields is dependent on the length of the longest entry in the respective column.

38. The control system as claimed in claim 21, wherein the width of individual fields is dependent on the number of columns.

39. The control system as claimed in claim 21, wherein the at least one display area represents a radio function and the entries in the fields correspond to radio stations.

40. The control system as claimed in claim 39, wherein the entries in the matrix comprise radio stations which are received at a particular time as a function of a user selection or are stored in at least one transmitter list.
